(19) United States
(12) Patent Application Publication
(10) Pub. No.: US 2010/0097720 A1
(43) Pub. Date: Apr. 22, 2010

(54) MAGNETIC RECORDING/REPRODUCING APPARATUS AND METHOD OF MANUFACTURING THE SAME

(75) Inventors: Nobutaka Ihara, Kawasaki (JP); Hiroto Takeshita, Kawasaki (JP); Yuji Ito, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/553,835

(22) Filed: Sep. 3, 2009

(30) Foreign Application Priority Data
Oct. 21, 2008 (JP) 2008-271316

(51) Int. Cl. G11B 5/187; B05D 5/12

(52) U.S. Cl. 360/122; 427/131; G9B/5.105

(57) ABSTRACT

According to one embodiment, a magnetic recording/reproducing apparatus includes a magnetic head and a magnetic recording medium. The magnetic recording medium includes a recording layer formed of a hard magnetic layer and a soft magnetic layer. The hard magnetic layer has a bit width corresponding to a length of a bit island in a radial direction of the magnetic recording medium. The soft magnetic layer is arranged on the hard magnetic layer. The soft magnetic layer has a width smaller than the bit width and is arranged at a position displaced in a direction away from an off-track portion of the leading edge of the magnetic head skewed at an angle.

### CROSS-REFERENCE TO RELATED APPLICATIONS

This application is based upon and claims the benefit of priority from Japanese Patent Application No. 2008-271316, filed Oct. 21, 2008, the entire contents of which are incorporated herein by reference.

### BACKGROUND

1. Field

One embodiment of the invention relates to a magnetic recording/reproducing apparatus and a method of manufacturing the magnetic recording/reproducing apparatus.

2. Description of the Related Art

The increasing demand for magnetic recording media with higher storage capacity in recent years has motivated development of technology for increasing recording density. Bit-patterned media approach is well known as one of technologies of increasing storage density of magnetic recording media. Meanwhile, it is inevitable that high-density bit-patterned media of high storage capacity have narrow track pitches. When data is written in a magnetic recording medium of which track pitches are narrow, adjacent track erasure is likely to occur.

Japanese Patent Application Publication (KOKAI) No. H08-77544 discloses a conventional technology related to a high-recording-density magnetic recording medium. With the conventional technology, as illustrated in FIG. 9, a recording layer on a substrate of a magnetic recording medium has a double layer structure made of a hard magnetic layer and a soft magnetic layer. FIG. 9 is a schematic cross-sectional view of a double-layered magnetic recording medium according to the conventional technology. As a conventional technology for preventing the adjacent track erasure, arranging magnetic dots at positions displaced in the down-track direction depending on a skew angle of a write head has been recently disclosed in Japanese Patent Application Publication (KOKAI) No. 2008-16072.

However, the conventional technologies can cause the recording density to decrease or the adjacent track erasure to occur.

More specifically, with the conventional technology that adopts the double layer structure, particularly when the write head is skewed at an angle, a portion of a leading edge of a main pole of the write head can be positioned outside a target track, which can result in adjacent track erasure. When the conventional technology of arranging magnetic dots at positions displaced in the down-track direction depending on the skew angle is employed, the recording density decreases because the magnetic dots are arranged at the displaced positions.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic view of a magnetic recording medium segmented into zones according to an embodiment of the invention;

FIG. 2A is an exemplary schematic perspective view of a bit island in a zone 1 illustrated in FIG. 1 in the embodiment;

FIG. 2B is an exemplary schematic perspective view of a bit island in a zone 15 illustrated in FIG. 1 in the embodiment;

FIG. 2C is an exemplary schematic perspective view of a bit island in a zone 25 illustrated in FIG. 1 in the embodiment;

FIG. 3 is an exemplary schematic diagram depicting a positional relationship between bit islands and a write head in the zone 1 in the embodiment;

FIG. 4 is an exemplary schematic diagram illustrating a positional relationship between a write head and bit cells in an at-center arrangement in the embodiment;

FIG. 5 is an exemplary schematic diagram illustrating a positional relationship between a write head and bit cells in an off-center arrangement in the embodiment;

FIG. 6A is an exemplary schematic diagram illustrating a mold pressed onto photo-setting resin applied to a hard magnetic layer in the embodiment;

FIG. 6B is an exemplary schematic diagram illustrating UV irradiation in the embodiment;

FIG. 6C is an exemplary schematic diagram illustrating pattern transfer in the embodiment;

FIG. 6D is an exemplary schematic diagram illustrating removal of remaining pieces of the mold by RIE in the embodiment;

FIG. 6E is an exemplary schematic diagram illustrating formation of the bit pattern on the hard magnetic layer in the embodiment;

FIG. 6F is an exemplary schematic diagram illustrating deposition of the soft magnetic layer by sputtering in the embodiment;

FIG. 6G is an exemplary schematic diagram of a second mold pressed onto photo-setting resin applied to the soft magnetic layer in the embodiment;

FIG. 6H is an exemplary schematic diagram illustrating UV irradiation in the embodiment;

FIG. 6I is an exemplary schematic diagram illustrating removal of remaining pieces of the second mold by RIE in the embodiment;

FIG. 6J is an exemplary schematic diagram illustrating formation of the bit pattern on the soft magnetic layer in the embodiment;

FIG. 7A is an exemplary schematic diagram of a bit island before the second mold is pressed onto the photo-setting resin in the embodiment;

FIG. 7B is an exemplary schematic diagram illustrating the state in which application of the photo-setting resin has been performed in the embodiment;

FIG. 7C is an exemplary schematic diagram illustrating the state in which the second mold has been pressed onto the photo-setting resin and then subjected to UV irradiation in the embodiment;

FIG. 7D is an exemplary schematic diagram illustrating the state in which the second mold has been removed and thereafter the remaining pieces of the second mold have been removed by RIE in the embodiment;

FIG. 7E is an exemplary schematic diagram illustrating the state in which the pattern has been formed on the soft magnetic layer in the embodiment;

FIG. 8 is an exemplary schematic top view illustrating an exemplary configuration of a magnetic recording/reproducing apparatus in the embodiment; and

FIG. 9 is an exemplary schematic cross-sectional view of a double-layered magnetic recording medium according to a conventional technology.

### DETAILED DESCRIPTION

Various embodiments according to the invention will be described hereinafter with reference to the accompanying drawings. In general, according to one embodiment of the invention, a magnetic recording/reproducing apparatus comprises a magnetic head and a magnetic recording medium including a recording layer. The recording layer is formed of a hard magnetic layer and a soft magnetic layer. The hard magnetic layer is configured to have a bit width corresponding to a length of a bit in a radial direction of the magnetic recording medium. The soft magnetic layer is arranged on the hard magnetic layer. The soft magnetic layer is configured to have a width smaller than the bit width and is arranged at a position displaced in a direction away from an off-track portion of the leading edge of the magnetic head skewed at an angle.

According to another embodiment of the invention, there is provided a method of manufacturing a magnetic recording/reproducing apparatus that comprises a magnetic head and a magnetic recording medium including a recording layer. The method comprises: arranging a hard magnetic layer configured to have a bit width corresponding to a length of a bit in a radial direction of the magnetic recording medium in the recording layer; and arranging a soft magnetic layer configured to have a width smaller than the bit width on the hard magnetic layer at a position displaced in a direction away from an off-track portion of the leading edge of the magnetic head skewed at an angle.

A magnetic recording medium according to an embodiment of the invention may be, for example, a perpendicular magnetic recording medium (bit-patterned medium) that comprises a recording layer on which data is to be recorded. In the recording layer, bits (magnetic grains) (hereinafter, “bit islands”) are regularly arranged. Generally, a bit-patterned medium is configured such that the bit length of the bit island in the radial direction of the magnetic recording medium is larger than the circumferential bit width of the bit island. The bit islands are arranged on a substrate, such as a glass substrate. A bit-patterned medium generally comprises an underlayer, an intermediate layer, and a recording layer.

The magnetic recording/reproducing apparatus comprises a magnetic head and such a magnetic recording medium. The magnetic recording medium comprises a recording layer including a hard magnetic layer and a soft magnetic layer. The hard magnetic layer has a bit width of the length of a bit island in a radial direction of the magnetic recording medium. The soft magnetic layer has a width smaller than the bit width and is arranged on the hard magnetic layer at a position displaced in a direction away from an off-track portion of the leading edge of the magnetic head that is skewed at an angle.

More specifically, the magnetic recording medium provided to the magnetic recording/reproducing apparatus comprises the recording layer, on which data is to be recorded, on the substrate. The magnetic recording medium has a double layer structure formed of the hard magnetic layer and the soft magnetic layer. The hard magnetic layer is made of a hard magnetic material that is relatively less easily magnetized or demagnetized while the soft magnetic layer is made of a soft magnetic material that is relatively easily magnetized or demagnetized. The magnetic recording medium, which is circular, comprises a plurality of data tracks. The magnetic recording/reproducing apparatus is provided with a write head that comprises a main pole and moves over the data tracks in a cross-track direction.

The hard magnetic layer has a bit width Bw that is equal to the length of the bit island in the radial direction of the magnetic recording medium. The soft magnetic layer has a soft layer width Sw that is smaller than the bit width Bw of the hard magnetic layer. The soft magnetic layer is configured to have the width smaller than that of the hard magnetic layer (Bw>Sw) to reduce adjacent track erasure caused by magnetic flux leakage in the cross-track direction when writing operation is performed by using the write head.

Meanwhile, the write head can be skewed at an angle while moving over the circular magnetic recording medium, causing a portion (hereinafter, “off-track portion”) of the leading edge of the main pole of the write head to be positioned outside a target track. The soft magnetic layer whose width is smaller than that of the hard magnetic layer is arranged at a position displaced in a direction away from the off-track portion. The soft magnetic layer is arranged in the displaced manner to further reduce the adjacent track erasure caused by the magnetic flux leakage.

In this manner, the magnetic recording medium provided to the magnetic recording/reproducing apparatus comprises the recording layer that is arranged on the substrate. In the recording layer, the soft magnetic layer whose width is smaller than that of the hard magnetic layer is arranged on the hard magnetic layer. The soft magnetic layer is arranged at the position displaced in the direction away from the off-track portion of the leading edge of the write head skewed at an angle. Accordingly, the magnetic recording medium can reduce the adjacent track erasure while maintaining a high recording density.

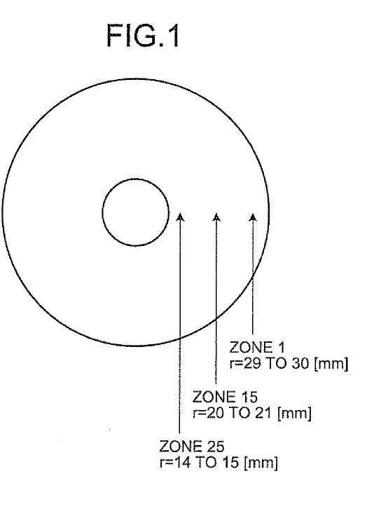

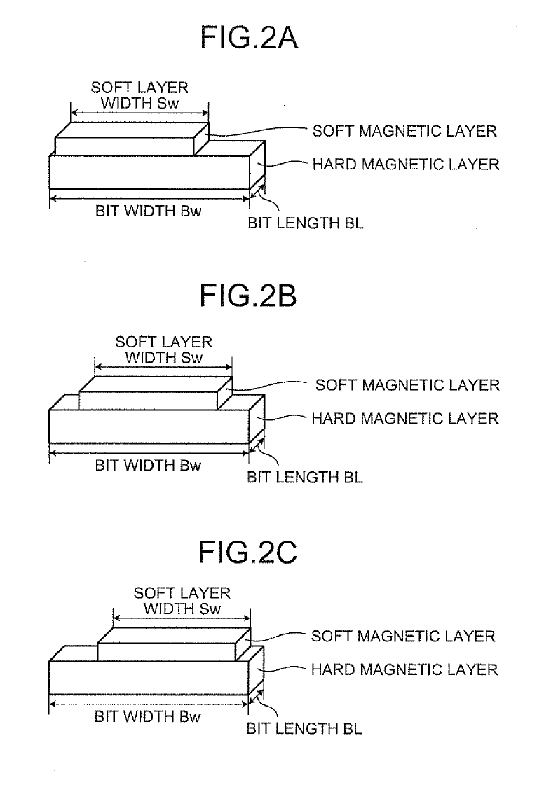

The position of the soft magnetic layer will be described with reference to FIGS. 1 to 2C. FIG. 1 is a schematic view of the magnetic recording medium according to the embodiment. The magnetic recording medium is segmented into zones, such as zone 1, zone 15, and zone 25. FIG. 2A illustrates an example of a bit island in the zone 1. FIG. 2B illustrates an example of a bit island in the zone 15. FIG. 2C illustrates an example of a bit island in the zone 25.

More specifically, the magnetic recording medium is segmented into zones at predetermined intervals in the radial direction of the magnetic recording medium. A half-width-difference value is calculated by halving a value obtained by subtracting the width of the soft magnetic layer from the bit width. A maximum off-track portion is a portion of the leading edge of the write head positioned outside a target track when the write head is skewed at a maximum skew angle. The soft magnetic layer is arranged in each zone such that, when the half-width-difference value is larger than a maximum width, which is the width of the maximum off-track portion, an end of the soft magnetic layer is arranged at a position displaced from an end of the bit island in the direction away from the leading edge by the maximum width.

For example, as illustrated in FIG. 1, a magnetic recording medium of which diameter is 2.5 inches can be segmented in the radial direction of the recording medium into zones, i.e., the zone 1 ranging from 29 to 30 millimeters in track radius (r=29 to 30 mm), the zone 15 (r=20 to 21 mm), and the zone 25 (r=14 to 15 mm). In the embodiment, the magnetic recording medium is described by way of example as being segmented at intervals of 1 millimeter; however, the interval is not limited to 1 millimeter. Besides, the number of zones created by the segmentation depends on the size (radius) of the magnetic recording medium.

The position of the soft magnetic layer in each of the zones 1, 15, and 25 will be described.

As illustrated in FIG. 2A, a bit island in the zone 1 is configured by depositing the soft magnetic layer that has the radial soft layer width Sw on the hard magnetic layer that has the radial bit width Bw and a circumferential bit length BL.

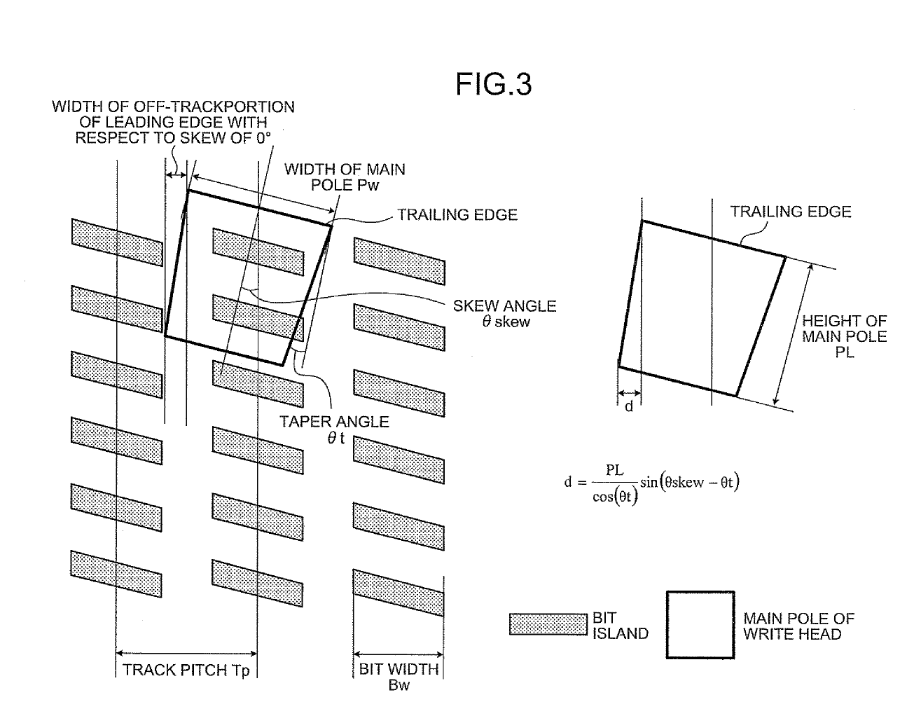

FIG. 3 illustrates a positional relationship between bit islands and the write head in the zone 1, in which PL denotes a height of the main pole, θt denotes a taper angle of the main pole, and θsm₁ denotes a maximum skew angle that is a maximum value of skew angle θskew₁ in the zone 1. A half-width-difference value ((Bw−Sw)/2) is calculated by halving the difference between the bit width Bw and the soft layer width Sw. If a maximum width d (=PL sin(θsm₁−θt₁)/cos θt₁) that is a width of a maximum off-track portion in the zone 1 is larger than the half-width-difference value ((Bw−Sw)/2>d), the soft magnetic layer is arranged such that an end of the soft magnetic layer is displaced from an end of the bit island in the direction away from the maximum off-track portion of the leading edge by the maximum width d.

The trailing edge and the bit island are preferably parallel to each other as illustrated in FIG. 3 so that a magnetic field is produced more uniformly at the bit island.

In short, the soft magnetic layer in the zone 1 is displaced inward of the magnetic recording medium to lessen influence exerted by magnetic flux leakage.

As illustrated in FIG. 2B, a bit island in the zone 15 is configured by depositing the soft magnetic layer that has the radial soft layer width Sw on the hard magnetic layer that has the radial bit width Bw and the circumferential bit length BL.

In FIG. 2B, θsm₁₅ denotes a maximum skew angle that is a maximum value of skew angle θskew₁₅ in the zone 15. If the maximum width d (=PL sin(θsm₁₅−θt₁₅)/cos θt₁₅) in the zone 15 is larger than the half-width-difference value ((Bw−Sw)/2>d), the soft magnetic layer is positioned such that the end of the soft magnetic layer is displaced from the end of the bit island in the direction away from the maximum off-track portion of the leading edge by the maximum width d.

As in the zone 1, the trailing edge and the bit island are preferably parallel to each other so that a magnetic field is produced more uniformly at the bit island.

In short, the soft magnetic layer in the zone 15 is arranged near the width center of the bit island to lessen influence exerted by magnetic flux leakage.

As illustrated in FIG. 2C, a bit island in the zone 25 is configured by depositing the soft magnetic layer that has the radial soft layer width Sw on the hard magnetic layer that has the radial bit width Bw and the circumferential bit length BL.

In FIG. 2C, θsm₂₅ denotes a maximum skew angle that is a maximum value of skew angle θskew₂₅ in the zone 25. If the maximum width d (=PL sin(θsm₂₅−θt₂₅)/cos θt₂₅) in the zone 25 is larger than the half-width-difference value ((Bw−Sw)/2>d), the soft magnetic layer is positioned such that the end of the soft magnetic layer is displaced from the end of the bit island in the direction away from the maximum off-track portion of the leading edge by the maximum width d.

As in the zone 1 and the zone 15, the trailing edge and the bit island are preferably parallel to each other so that a magnetic field is produced more uniformly at the bit island.

In short, the soft magnetic layer in the zone 25 is displaced outward of the magnetic recording medium to lessen influence exerted by magnetic flux leakage.

The soft layer width is uniform throughout all the zones and corresponds to a value obtained by subtracting the maximum width from the bit width in all the zones.

For example, the soft layer width Sw is uniform throughout all the zones and calculated as the difference between the bit width Bw and the maximum width dm (Sw=Bw−dm). Because data read/write performance depends on the width (size) of the soft magnetic layer, all the bit islands are configured to have the single soft layer width.

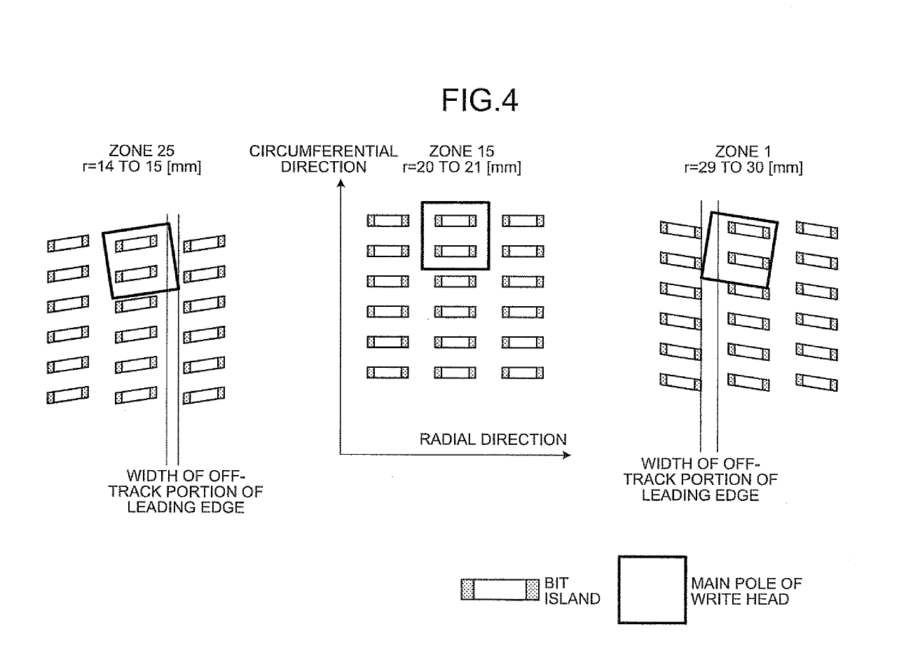

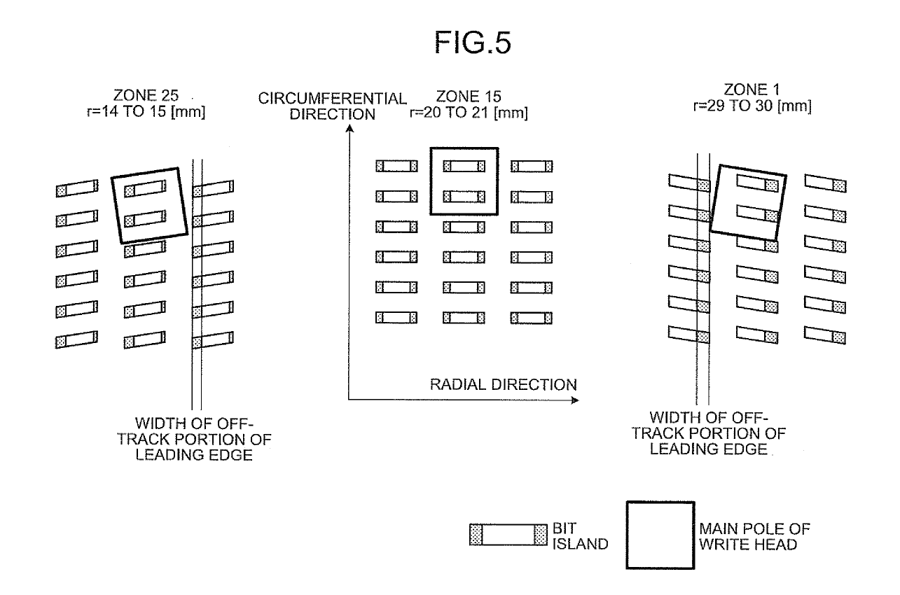

The positional relationship between bit islands and the write head will be described below with reference to FIG. 4 and FIG. 5. For clarifying an advantage in arranging the soft magnetic layer at the displaced position (hereinafter, “off-center arrangement”) according to the embodiment, two arrangements for the double layer structure made of a hard magnetic layer and a soft magnetic layer will be described below. In a first one of the arrangements; i.e., the off-center arrangement, the soft magnetic layer is arranged at the displaced position while in a second one of the arrangements; i.e., an at-center arrangement, the soft magnetic layer is arranged without being displaced. FIG. 4 illustrates a positional relationship between the write head and bit islands in the at-center arrangement. FIG. 5 illustrates a positional relationship between the write head and bit islands in the off-center arrangement in the embodiment.

When the soft magnetic layer is arranged near a width center of a bit island (at-center arrangement) as illustrated in FIG. 4, the leading edge of the write head has an off-track portion that is positioned outside a target track. Hence, influence of magnetic leakage flux due to the off-track portion is exerted particularly in the zone 1 and the zone 25.

More specifically, the at-center arrangement permits to lessen the influence of magnetic leakage flux due to the off-track portion of the leading edge as compared to an arrangement of a conventional technology in which a double layer structure is made of a hard magnetic layer and a soft magnetic layer that have the same width (length); however, some zones can be affected by magnetic leakage flux in the at-center arrangement. Put another way, in the at-center arrangement, influence of magnetic leakage flux is exerted in a zone where the write head is skewed relative to the bit islands. The zone can be any one of one or more radially inner zones (for example, the zone 25) and one or more radially outer zones (for example, the zone 1) of the magnetic recording medium.

When the soft magnetic layer is arranged at the displaced position (off-center arrangement) as illustrated in FIG. 5, it is possible to further lessen influence exerted by magnetic leakage flux due to the off-track portion of the leading edge particularly in the zone 1 and the zone 25.

The off-center arrangement thus permits to further lessen the influence of magnetic leakage flux due to the off-track portion of the leading edge as compared to an arrangement of a conventional technology in which a soft magnetic layer whose width is smaller than a width of a hard magnetic layer is arranged near a width center of the hard magnetic layer. Put another way, in the off-center arrangement, influence of magnetic leakage flux can be further lessened in zones where the write head is skewed relative to the bit islands. The zones can be one or more radially inner zones (for example, the zone 25) and radially outer zones (for example, the zone 1) of the magnetic recording medium.

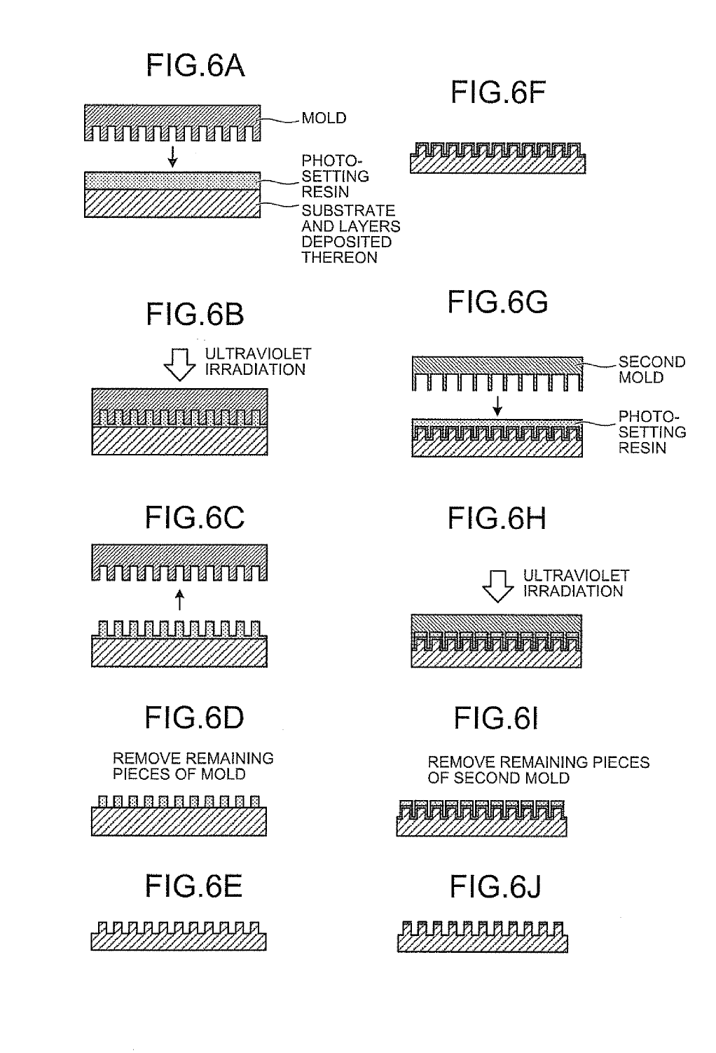

A method of manufacturing the magnetic recording/reproducing apparatus will be described with reference to FIGS. 6A to 6J. More specifically, the method for manufacturing the magnetic recording/reproducing apparatus that comprises the magnetic head and the magnetic recording medium will be described. The magnetic recording medium comprises bit islands that are regularly arranged and the recording layer that comprises the hard magnetic layer and the soft magnetic layer. The method comprises forming the recording layer by arranging the soft magnetic layer and the hard magnetic layer such that the hard magnetic layer has the bit width of the length of the bit island in the radial direction of the magnetic recording medium, and the soft magnetic layer has the width smaller than the bit width and is arranged on the hard magnetic layer at the position displaced from the width center of the hard magnetic layer in the direction away from the off-track portion. The off-track portion is a portion of the leading edge positioned outside a target track when the magnetic head is skewed at a skew angle.

A specific example of the method is described below. A soft underlayer (SUL) is deposited by sputtering on a substrate in thickness of 50 nanometers. On the SUL, a non-magnetic intermediate layer is deposited in thickness of 5 nanometers, and further a CoCrPt alloy is deposited in thickness of 10 nanometers to form a hard magnetic layer. The hard magnetic layer can have any one of a single layer structure and a multi-layer structure.

After applying photo-setting resin to the hard magnetic layer, a mold is pressed onto the photo-setting resin (FIG. 6A), which is then irradiated with ultraviolet (UV) rays (FIG. 6B). Thereafter, the mold is removed. Hence, pattern transfer has been performed (FIG. 6C). After remaining pieces of the mold are removed by reactive ion etching (RIE) (FIG. 6D), a bit pattern is formed on the hard magnetic layer by dry etching (FIG. 6E).

FIG. 6A illustrates the mold pressed onto the photo-setting resin in the embodiment. FIG. 6B illustrates UV irradiation in the embodiment. FIG. 6C illustrates the pattern transfer in the embodiment. FIG. 6D illustrates removal of the remaining pieces of the mold by RIE in the embodiment. FIG. 6E illustrates formation of the bit pattern on the hard magnetic layer in the embodiment.

Each bit island to be formed can be, for example, 44 nanometers in bit width and 20 nanometers in bit length. The hard magnetic layer can be formed such that, for example, bit-to-bit spacing in a cross-track direction is 64 nanometers and bit-to-bit spacing in the down-track direction is 40 nanometers.

An NiFe alloy is deposited in thickness 10 nanometers on the hard magnetic layer to form the soft magnetic layer by sputtering (FIG. 6F), to which photo-setting resin is then applied. A second mold is pressed onto the photo-setting resin (FIG. 6G), which is then irradiated with UV rays (FIG. 6H). Thereafter, the second mold is removed. Hence, pattern transfer has been performed. Remaining pieces of the second mold are removed by RIE (FIG. 6I). Thereafter, a pattern is formed on the soft magnetic layer by dry etching (FIG. 6J). The pattern of the soft magnetic layer is formed such that the soft magnetic layer is piggybacked on a portion of each bit island.

FIG. 6F illustrates deposition of the soft magnetic layer by sputtering in the embodiment. FIG. 6G illustrates the second mold pressed onto the photo-setting resin in the embodiment. FIG. 6H illustrates UV irradiation in the embodiment. FIG. 6I illustrates removal of the remaining pieces of the second mold by RIE in the embodiment. FIG. 6J illustrates formation of the pattern on the soft magnetic layer in the embodiment.

The length of the soft magnetic layer on each bit island in the down-track direction is, for example, 20 nanometers that is equal to the bit length while the length of the soft magnetic layer in the cross-track direction is, for example, 30 nanometers that is smaller than the bit width. The bit islands on each of which the hard magnetic layer and the soft magnetic layer are deposited are subjected to surface smoothing and/or the like process. The surface can be smoothed by filling gaps between recording bit islands with a non-magnetic material. Thereafter, carbon is deposited in thickness of 3 nanometers on the surface by chemical vapor deposition (CVD) to form a protective layer. A lubricant is then applied onto the protective layer.

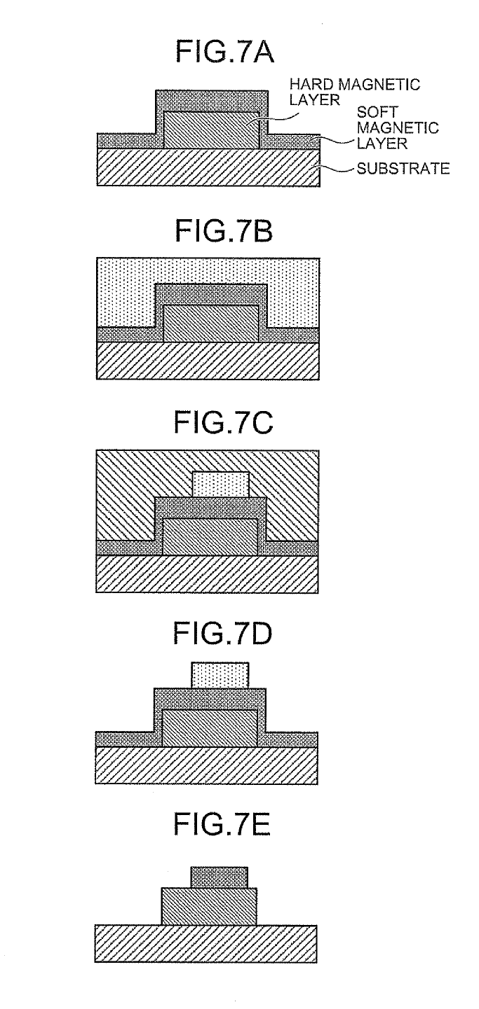

A method of manufacturing the magnetic recording medium, in which the soft magnetic layer is arranged in a displaced manner, that is provided in the magnetic recording/reproducing apparatus according to the embodiment will be described in detail with reference to FIGS. 7A to 7E.

FIG. 7A illustrates a bit island on which the soft magnetic layer has been deposited but the second mold illustrated in FIG. 6G is not pressed onto the layers yet. As illustrated in FIG. 7B, photo-setting resin is then applied to the soft magnetic layer. As illustrated in FIG. 7C, thereafter the second mold is pressed onto the photo-setting resin, which is then irradiated with UV rays. As illustrated in FIG. 7D, the second mold is removed. Hence, pattern transfer has been performed. Thereafter, remaining pieces of the second mold are removed by RIE. As illustrated in FIG. 7E, a pattern is formed on the soft magnetic layer by dry etching.

FIG. 7A illustrates a bit island of the state in which the second mold is not yet pressed onto the photo-setting resin in the embodiment. FIG. 7B illustrates the state in which application of the photo-setting resin has been performed in the embodiment. FIG. 7C illustrates the state in which the second mold has been pressed onto the photo-setting resin and then subjected to UV irradiation in the embodiment. FIG. 7D illustrates the state in which the second mold has been removed and thereafter the remaining pieces of the second mold have been removed by RIE in detail in the embodiment. FIG. 7E illustrates the state in which the second mold has been removed and thereafter the remaining pieces of the second mold have been removed by RIE in the embodiment.

In this manner, in the method of manufacturing the magnetic recording/reproducing apparatus of the embodiment, the molds that cause the soft magnetic layer to be arranged on the hard magnetic layer at the position displaced from the width center of the hard magnetic layer in the direction away from the off-track portion, which is positioned outside a target track when the head is skewed, by a distance of the maximum width in each zone is pressed onto photo-setting resin.

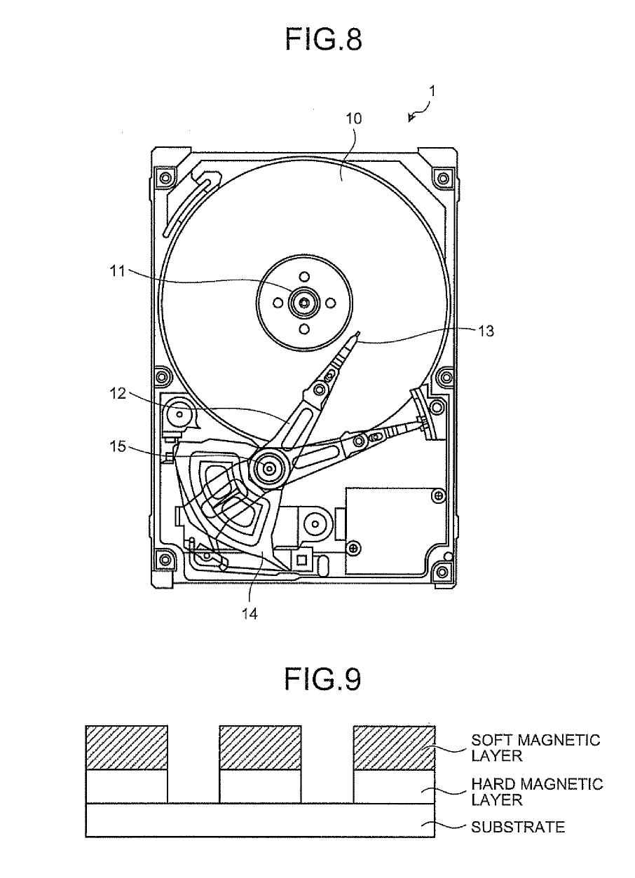

The configuration of a magnetic recording/reproducing apparatus 1 according to the embodiment will be described with reference to FIG. 8. FIG. 8 is a schematic top view of the magnetic recording/reproducing apparatus 1 according to the embodiment.

More specifically, the magnetic recording/reproducing apparatus comprises the magnetic head that comprises the leading edge and the magnetic recording medium that comprises data tracks. In the magnetic recording medium, bit islands are regularly arranged. The magnetic recording medium comprises the recording layer that comprises the hard magnetic layer and the soft magnetic layer. The hard magnetic layer has the bit width that is equal to the length of the bit island in the radial direction of the magnetic recording medium. The soft magnetic layer has the width that is smaller than the bit width and is arranged on the hard magnetic layer at the position displaced from the width center of the hard magnetic layer in the direction away from the off-track portion of the leading edge. The off-track portion is a portion of the leading edge positioned outside a target track when the magnetic head is skewed at a skew angle.

For example, as illustrated in FIG. 8, the magnetic recording/reproducing apparatus 1 can comprise a magnetic recording medium 10, a spindle motor 11, an arm 12, a magnetic head 13, a voice coil motor (VCM) 14, and a shaft 15. The magnetic recording medium 10 is a perpendicular magnetic recording medium that records various data at high density. The magnetic recording medium 10 is driven to rotate by the spindle motor 11.

The magnetic head 13 is arranged at one leading end of the arm 12 that is a head support mechanism. The magnetic head 13 reads and writes data from and to the magnetic recording medium 10. While the magnetic head 13 reads and writes data from and to the magnetic recording medium 10, the magnetic head 13 is kept floating closely over the magnetic recording medium 10 by lift produced by the magnetic recording medium 10 that spins.

The VCM 14, which is a head drive mechanism, is arranged on the other end of the arm 12. The VCM 14 drives the arm 12 to pivot about the shaft 15 so that the magnetic head 13 seeks across tracks of the magnetic recording medium 10 and changes a track to or from which data is to be written or read.

As set forth hereinabove, according to the embodiment, the magnetic recording medium 10 provided to the magnetic recording/reproducing apparatus 1 is a bit-patterned medium having a double layer structure, in which the soft magnetic layer whose width is smaller than that of the hard magnetic layer is arranged on the hard magnetic layer in the recording layer on the substrate. The soft magnetic layer is arranged at a position displaced in a direction away from the off-track portion of the leading edge of the write head skewed at an angle. Accordingly, even if the write head is skewed, it is possible to reduce adjacent track erasure as well as to maintain a high recording density.

For example, the magnetic recording medium 10 provided to the magnetic recording/reproducing apparatus 1 has a double layer structure formed of the hard magnetic layer and the soft magnetic layer. The hard magnetic layer is made of a hard magnetic material that is relatively less easily magnetized or demagnetized while the soft magnetic layer is made of a soft magnetic material that is relatively easily magnetized or demagnetized. The hard magnetic layer has a bit width Bw that is equal to the length of the bit island in the radial direction of the magnetic recording medium 10. The soft magnetic layer has a soft layer width Sw that is smaller than the bit width Bw of the hard magnetic layer. The soft magnetic layer is arranged at a position displaced in a direction away from the off-track portion of the leading edge of the write head that is skewed while moving over the circular magnetic recording medium 10. Accordingly, even if the write head is skewed, the magnetic recording/reproducing apparatus 1 can reduce adjacent track erasure while maintaining a high recording density.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic recording/reproducing apparatus comprising:
a magnetic head; and
a magnetic recording medium comprising a recording layer, the recording layer comprising
a hard magnetic layer configured to have a bit width corresponding to a length of a bit in a radial direction of the magnetic recording medium, and
a soft magnetic layer on the hard magnetic layer, the soft magnetic layer configured to have a width smaller than the bit width and be arranged at a position displaced in a direction away from an off-track portion of a leading edge of the magnetic head skewed at an angle.

2. The magnetic recording/reproducing apparatus of claim 1, wherein
the magnetic recording medium is segmented into predetermined zones in the radial direction of the magnetic recording medium, and
when half of a value obtained by subtracting the width of the soft magnetic layer from the bit width is larger than a maximum width of the off-track portion of the leading edge of the write head skewed at a maximum angle in a zone, the soft magnetic layer is arranged in the zone such that an end of the soft magnetic layer is displaced from an end of the bit in the direction away from the leading edge by the maximum width of the off-track portion.

3. The magnetic recording/reproducing apparatus of claim 2, wherein the soft magnetic layer is configured to have the width that is uniform throughout all the zones and that is equal to a value obtained by subtracting the maximum width of the off-track portion from the bit width in all the zones.

4. A method of manufacturing a magnetic recording/reproducing apparatus that comprises a magnetic head and a magnetic recording medium including a recording layer, the method comprising:
arranging a hard magnetic layer configured to have a bit width corresponding to a length of a bit in a radial direction of the magnetic recording medium in the recording layer; and
arranging a soft magnetic layer configured to have a width smaller than the bit width on the hard magnetic layer at a position displaced in a direction away from an off-track portion of a leading edge of the magnetic head skewed at an angle.
